(19) United States
(12) Patent Application Publication
(10) Pub. No.: US 2012/0306327 A1
(43) Pub. Date: Dec. 6, 2012

(54) ELECTRICITY GENERATING BICYCLE WHEEL ASSEMBLIES

(76) Inventors: Lan Lee, Palo Alto, CA (US); Shanshan Lee, Palo Alto, CA (US)

(21) Appl. No.: 13/151,824

(22) Filed: Jun. 2, 2011

(51) Int. Cl. B62J 6/12; H02K 7/18

(52) U.S. Cl. 310/67 A

(57) ABSTRACT

Provided are electricity generating bicycle wheel assemblies configured to generate electrical power. In certain embodiments, an electricity generating bicycle wheel assembly includes a hub, and an axle protruding through and rotatably attached to the hub, such that the axle is configured to rigidly attach to a bicycle frame on each side of the hub. The assembly also includes an electrical generator positioned within the hub and rigidly attached to the axle. The electrical generator includes a generator axle rotatably coupled to the hub such that rotation of the hub with respect to the axle facilitates rotation of the generator axle with respect to the electrical generator.

### FIELD

This application relates generally to electricity generating bicycle wheel assemblies and, more specifically, to an electrical generator attached to an axle of the bicycle wheel and configured to generate electricity during rotation of the bicycle wheel.

### BACKGROUND

The approaches described in this section could be pursued, but are not necessarily approaches that have been previously conceived. Therefore, unless otherwise indicated herein, the approaches described in this section are not prior art to the claims in this application and are not admitted to be prior art by inclusion in this section.

A bicycle generator, also known as a dynamo, typically includes a small generator body including a stator fixed to the frame of the bicycle and a rotor driven by frictional force produced by a bicycle wheel or tire in order to rotate the rotor relative to the stator to produce electricity. This type of generator tends to produce considerable noise and is mainly driven by the contact point between the wheel and rotor and makes it very difficult to maintain optimal contact between these two moving parts. For example, the wheel has to be perfectly aligned and any wobbling in the wheel, which is common, greatly interferes with performance of the bicycle and may cause this generator to become non-operational. Furthermore, this type of generator needs to be separately installed and maintained and is often susceptible to damage due to various uses of the bicycle (e.g., parking). Consequently, this type of generator has lost popularity in today's bicycle market. A more popular approach is to power lights and other bicycle electrical equipment with batteries. However, batteries are expensive and need continuous replacement. Batteries may also not be readily available when needed (e.g., riding at night in a remote area).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are various designs of electricity generating bicycle wheel assemblies configured to generate electrical power during operation of a bicycle or, more specifically, during rotation of a bicycle wheel. Unlike conventional bicycle generators, the electricity generating bicycle wheel assemblies proposed herein are integrated into a bicycle and do not need to be separately attached to the frame of the bicycle. This integration substantially simplifies installation of the generator on the bicycle. Furthermore, electricity generating bicycle wheel assemblies utilize various components of conventional wheels, thereby providing overall manufacturing costs savings. For example, a wheel axle is used to support various stationary components of the assembly, while the hub acts as the driver for movable components of the assembly. The hub may also be used to enclose various components of the assembly.

In certain embodiments, an electricity generating bicycle wheel assembly includes a hub, and an axle protruding through and rotatably attached to the hub, such that the axle is configured to rigidly attach to a bicycle frame on each side of the hub. The assembly also includes an electrical generator positioned within the hub and rigidly attached to the axle. The electrical generator includes a generator axle rotatably coupled to the hub such that rotation of the hub with respect to the axle facilitates rotation of the generator axle with respect to the electrical generator.

In certain embodiments, an electricity generating bicycle wheel assembly also includes one or more gears positioned within the hub and rotatably coupling the generator axle to the hub. The gear ratio of the one or more gears may be at least about 10, such that each rotation of the hub with respect to the axle facilitates multiple rotations of the generator axle with respect to the electrical generator.

In certain embodiments, an electricity generating bicycle wheel assembly also includes an electricity storage electrically positioned within the hub and electrically coupled to the electrical generator. Some examples of the electricity storage include a capacitor, a battery, a lithium ion battery, a lithium polymer battery, a nickel metal hydride battery, a nickel cadmium battery, and a lead acid battery. The life time of a battery may be in the range of 1,000 to 10,000 of charge/discharge cycles. A capacitor, on the other hand, may be used in up to a several million charge/discharge cycles. If a battery is used, the battery may be positioned within the hub or outside of the hub.

In certain embodiments, an electricity generating bicycle wheel assembly also includes one or more electrical leads electrically coupled to the electrical generator and extending outside of the hub. The one or more electrical leads may protrude inside the axle. The leads may be also connected to a slip contact ring. The slip contact ring may be used in addition or instead of protruding one or more electrical leads through the axle. Conductive components (e.g., metallic components) of the bicycle wheel assembly may be used as one of the electrical leads. Some examples of such components include the axle and the hub.

In certain embodiments, an electricity generating bicycle wheel assembly also includes a mounting strap rigidly coupling the electrical generator to the axle. The mounting strap may be wrapped around the axle. In the same or other embodiments, an electricity generating bicycle wheel assembly also includes a rim rigidly coupled to the hub. The rim is configured to receive a bicycle tire. The rim may be rigidly coupled to the hub by multiple spokes. Alternatively, the hub may extend to the rim and be in direct connection with the rim. In certain embodiments, an electricity generating bicycle wheel assembly includes one or more sprockets rigidly coupled to the hub.

Provided also is a bicycle including a frame and a wheel, which includes an electricity generating bicycle wheel assembly. Various examples of such an assembly are described below. In certain embodiments, the bicycle also includes another wheel that includes another (i.e., second) electricity generating bicycle wheel assembly. A bicycle may include one or more lights electrically coupled to the electrical generator of the electricity generating bicycle wheel assembly.

In certain embodiments, a bicycle also includes a connector including at least two electrical contacts electrically coupled to the electrical generator. The connector is configured for connection to one or more external electrical devices, such as a light and a cell phone. A bicycle may also include a battery electrically coupled to the electrical generator. The battery may be positioned inside the hub of the electricity generating bicycle wheel assembly or outside of this hub.

In certain embodiments, one or more a wire coils can be rigidly coupled to the axle. One or more magnets can be mounted inside the hub assembly such that when the hub rotates the one or more magnets rotate with the hub opposite the one or more stationary coils. When the one or more magnets pass the one or more wire coils, electric current will be generated in the one or more wire coils.

These and other embodiments are described further below with reference to the figures.

### BRIEF DESCRIPTION OF DRAWINGS

Embodiments are illustrated by way of example and not limitation in the figures of the accompanying drawings, in which like references indicate similar elements and in which:

FIG. 1A illustrates an electricity generating bicycle wheel assembly configured to generate electrical power, in accordance with certain embodiments.

FIG. 1B illustrates the same electricity generating bicycle wheel assembly prior to inserting the axle through the hub, in accordance with certain embodiments.

FIG. 1C illustrates the same electricity generating bicycle wheel assembly after inserting the axle through the hub, in accordance with certain embodiments.

FIG. 1D illustrates a different electricity generating bicycle wheel assembly that includes a hub formed as two rings positioned near two different ends of the axle, in accordance with certain embodiments.

FIG. 2A is a detailed schematic illustration of an electricity generating bicycle wheel assembly, in accordance with certain embodiments.

FIG. 2B-G are detailed schematic illustrations of other electricity generating bicycle wheel assemblies, in accordance with certain embodiments.

FIG. 3A-C illustrate an electricity generating bicycle wheel assembly with the electricity being generated in one or more wire coils rigidly attached to a stationary axle as the magnets mounted on and inside the hub assembly pass by one or more stationary wire coils.

FIG. 4 is a schematic representation of a bicycle having two wheels, one or both of which are equipped with electricity generating bicycle wheel assemblies, in accordance with certain embodiments.

### DETAILED DESCRIPTION

Provided are electricity generating bicycle wheel assemblies configured to generate electrical power. In certain embodiments, an electricity generating bicycle wheel assembly includes a hub, and an axle protruding through and rotatably attached to the hub, such that the axle is configured to rigidly attach to a bicycle frame on each side of the hub. The assembly also includes an electrical generator positioned within the hub and rigidly attached to the axle. The electrical generator includes a generator axle rotatably coupled to the hub such that rotation of the hub with respect to the axle facilitates rotation of the generator axle with respect to the electrical generator.

Unlike conventional bicycle generators, electricity generating bicycle wheel assemblies proposed herein are integrated into a bicycle and do not need to be separately attached to the frame of the bicycle. This integration substantially simplifies installation of the generator on the bicycle. Furthermore, electricity generating bicycle wheel assemblies utilize various components of conventional wheels, which provide overall manufacturing costs savings. For example, a wheel axle is used to support various stationary components of the assembly, while the hub acts as a driver for movable components of the assembly. The hub may also be used to enclose various components of the assembly.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

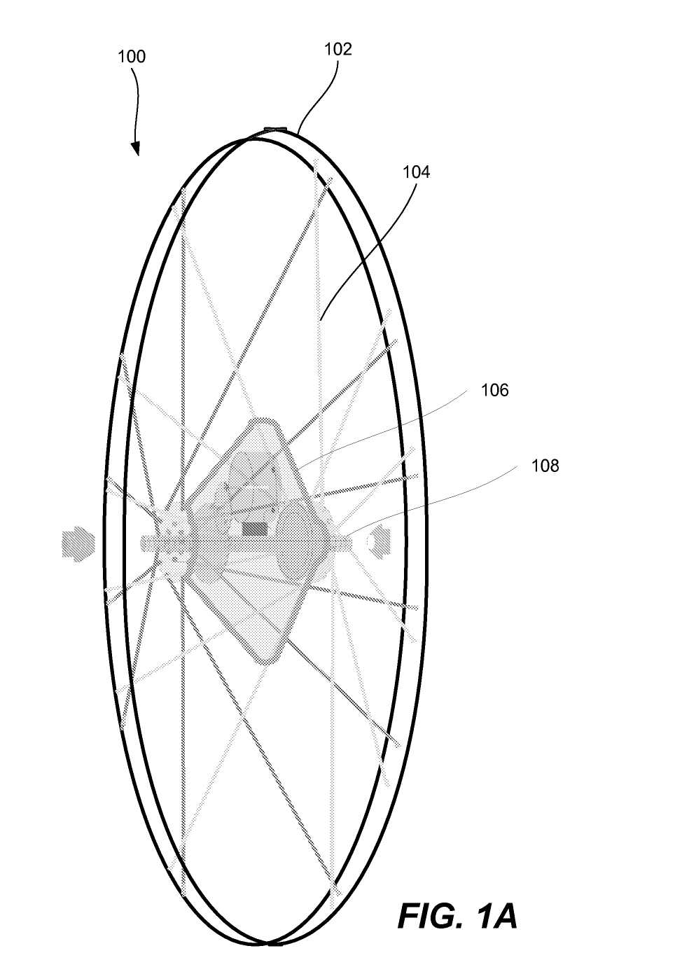

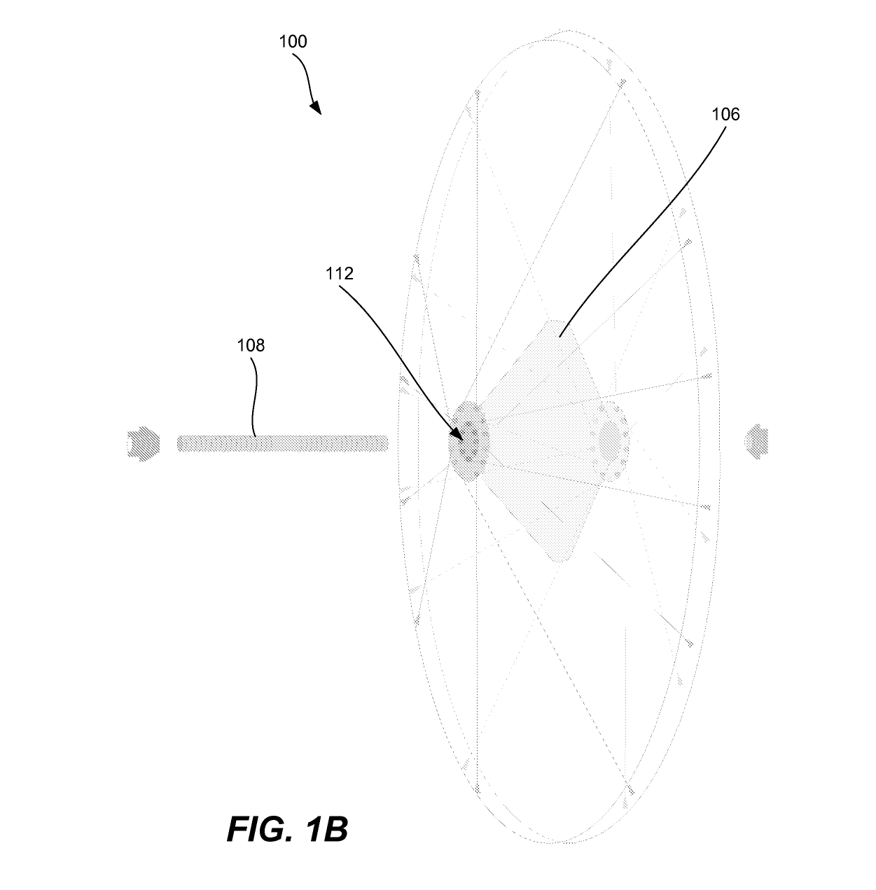

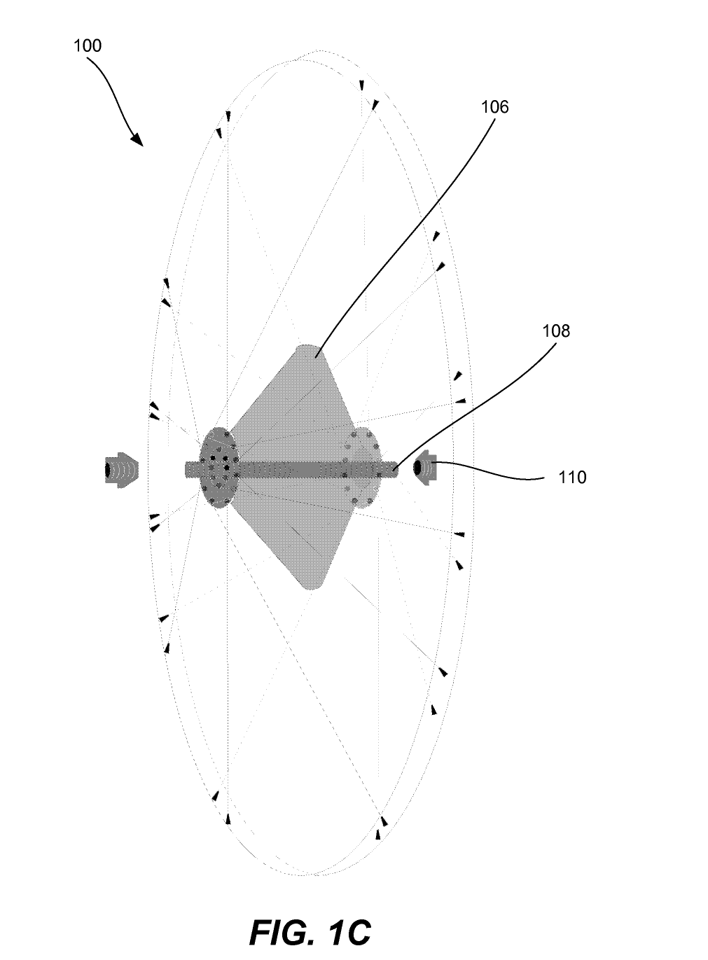

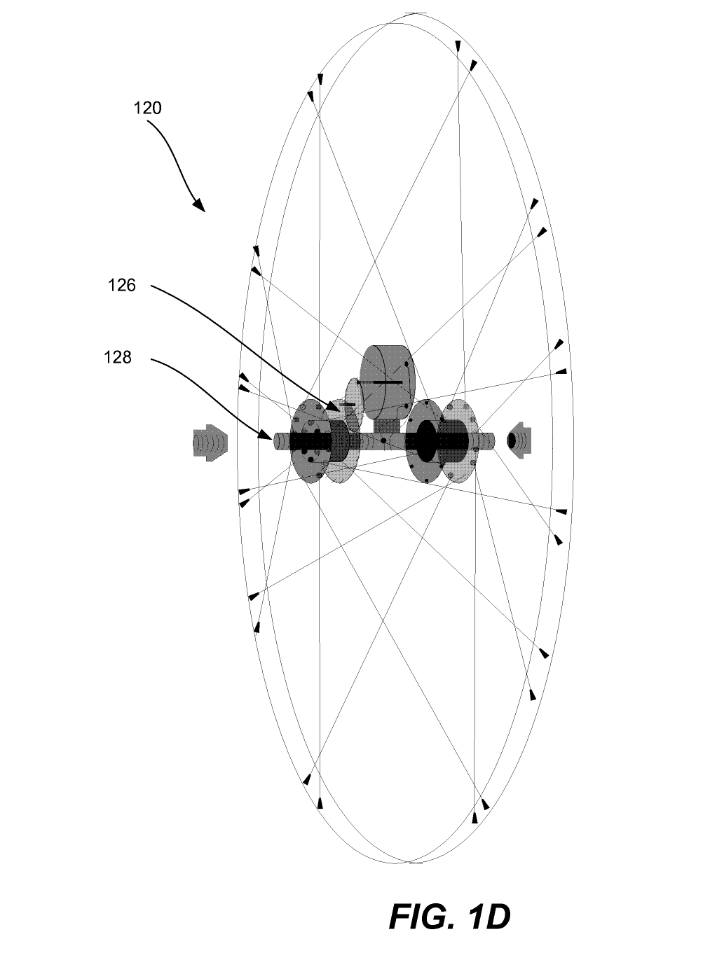

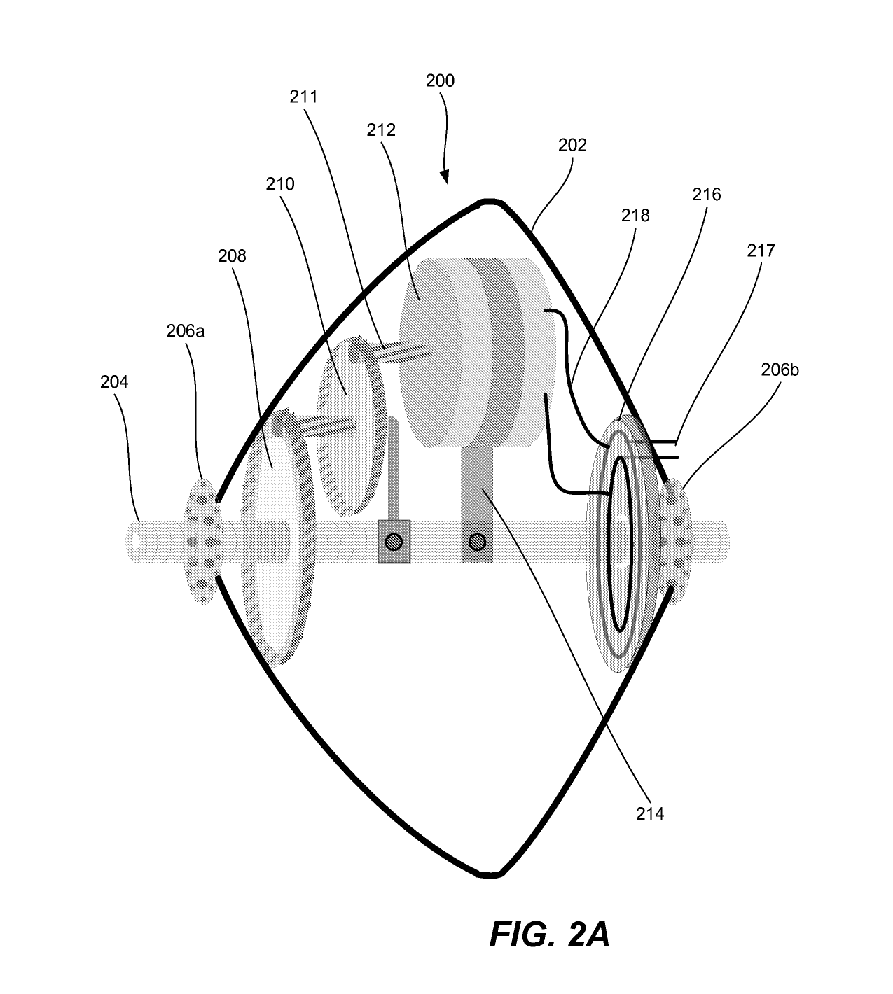

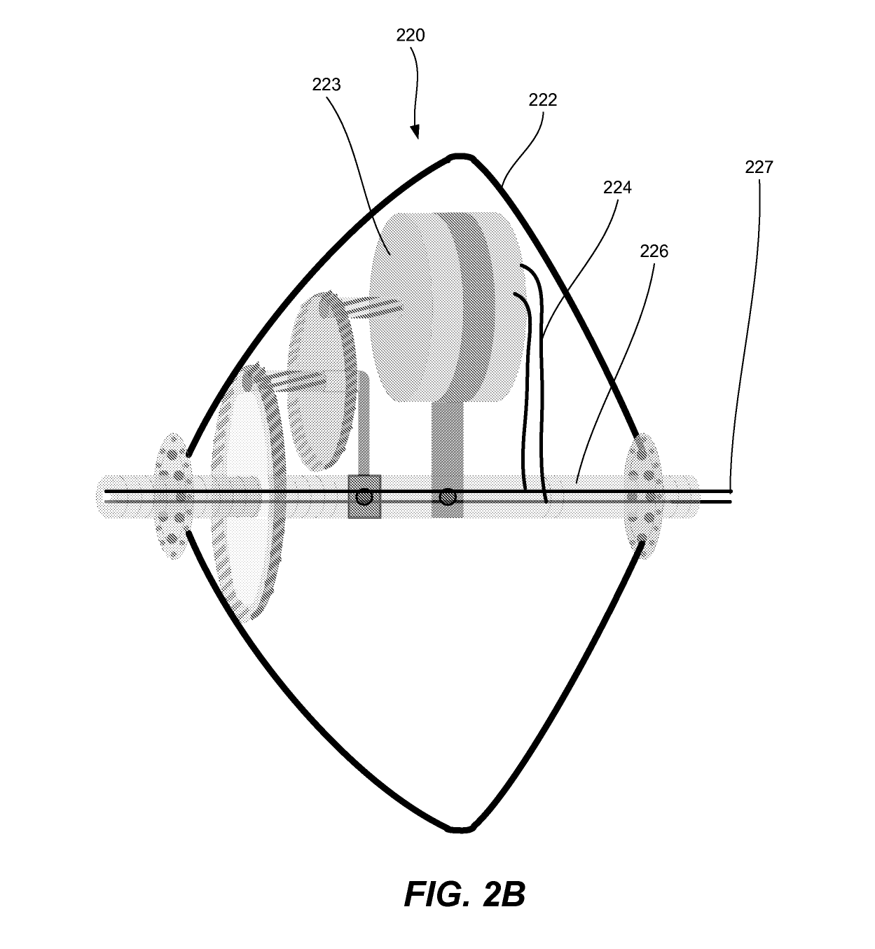

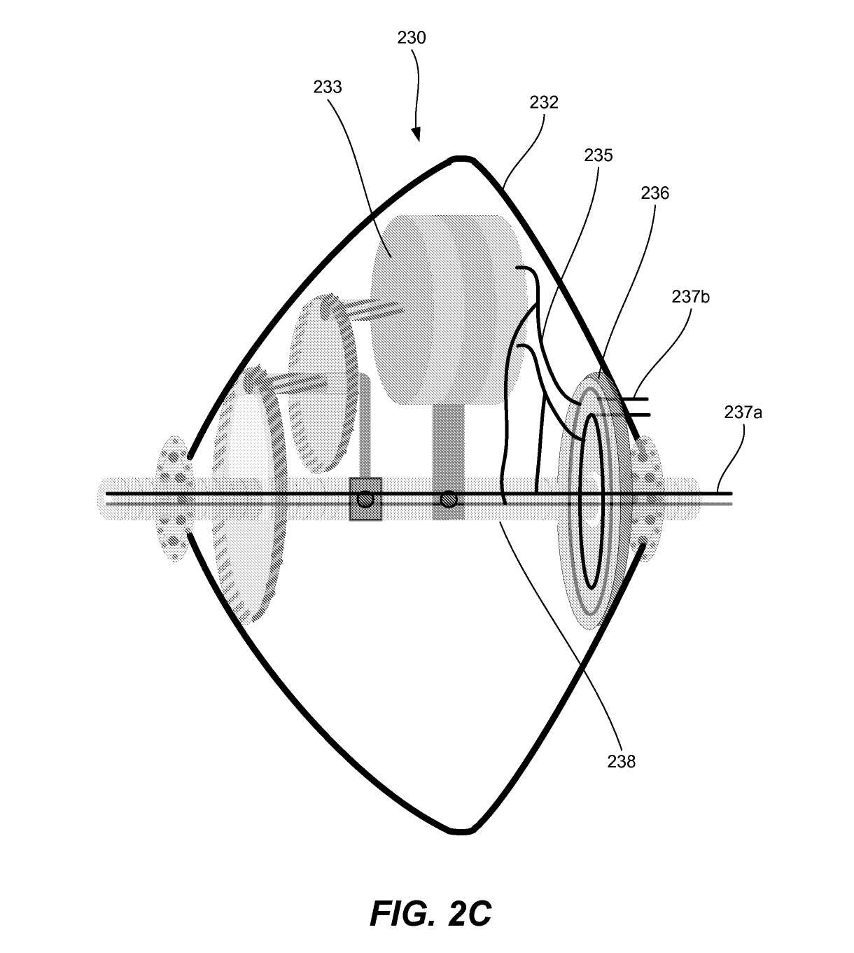

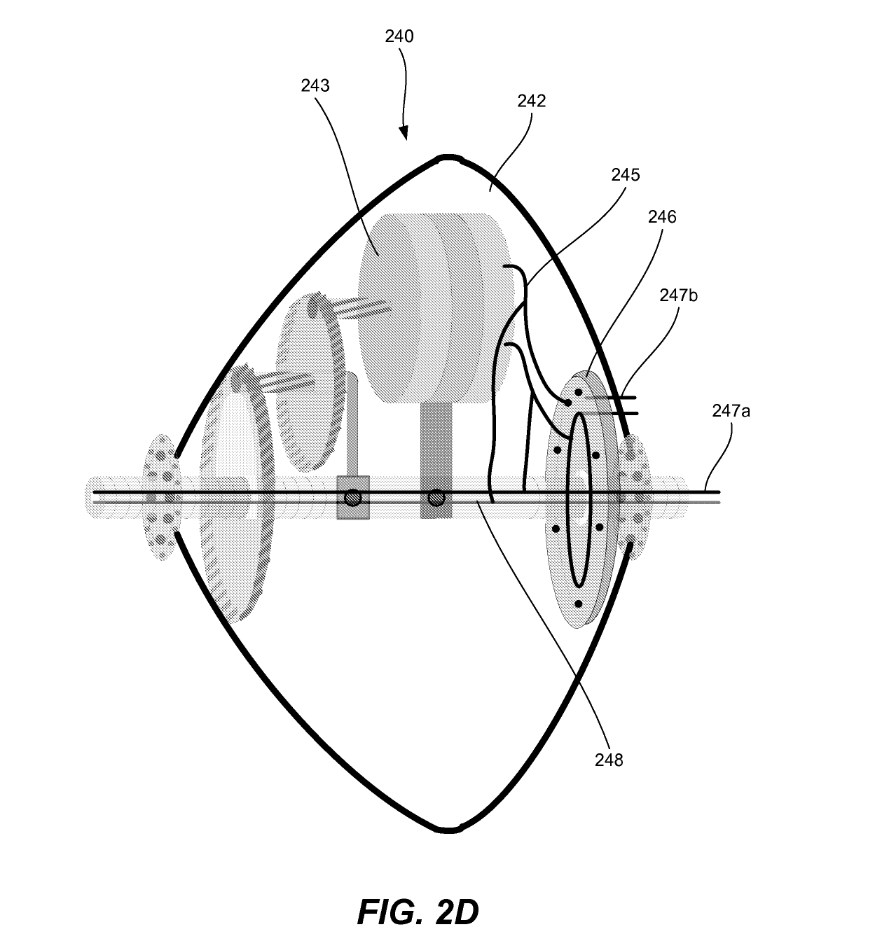

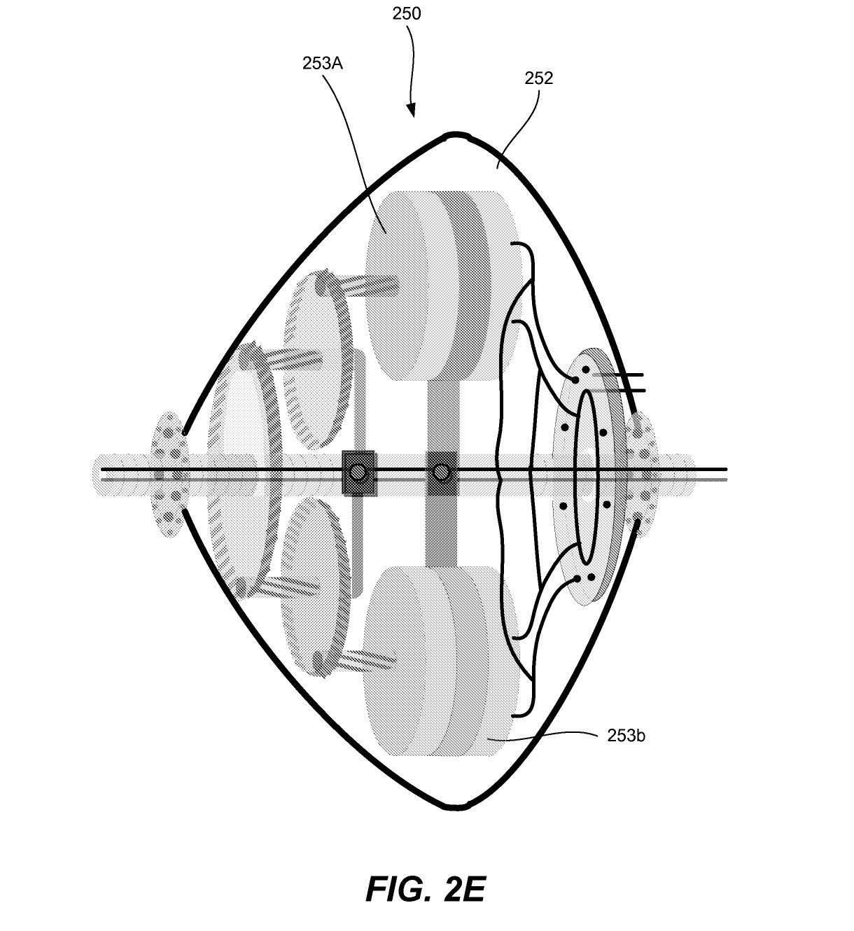

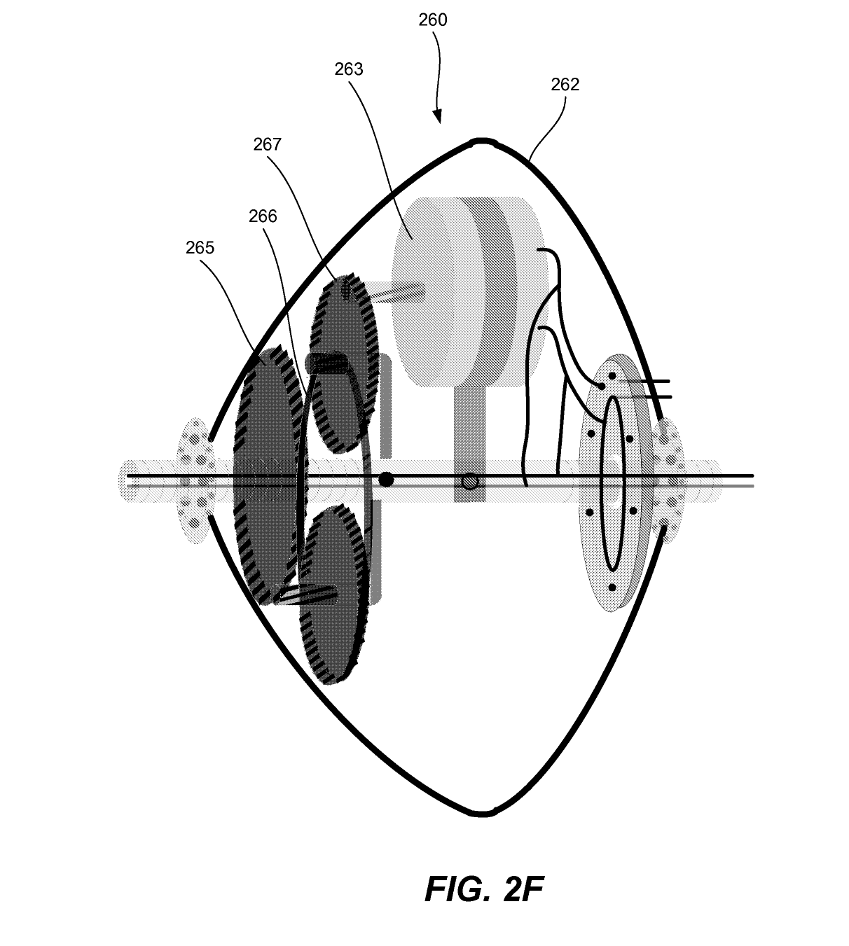

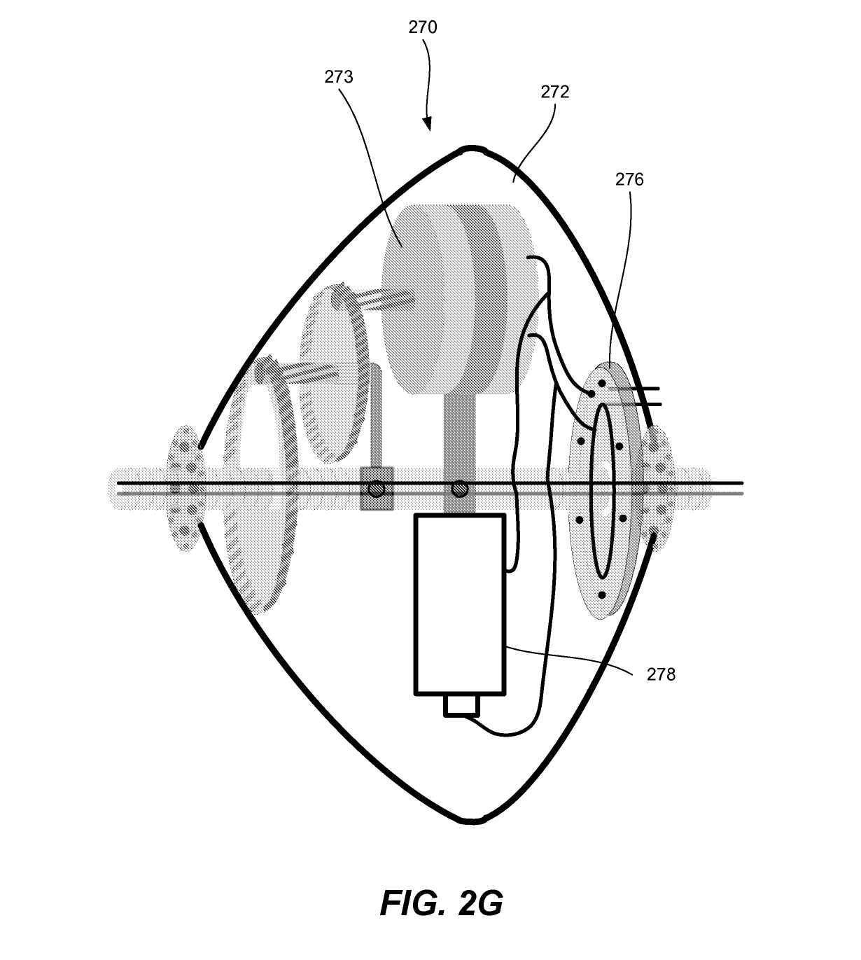

FIG. 1A illustrates an electricity generating bicycle wheel assembly 100 configured to generate electrical power, in accordance with certain embodiments. Electricity generating bicycle wheel assembly 100 includes a hub 106 rotatably coupled to an axle 108. Hub 106 may form a complete or partial enclosure for housing an electrical generator and various other components used for supporting the electrical generator and provide rotation of the generator's axle when the hub 106 rotates with respect to axle 108. These components are further described below with reference to FIGS. 2A-2G.

In certain embodiments, electricity generating bicycle wheel assembly 100 may include a rim 102 for receiving a bicycle tire. Rim 102 is rigidly coupled to hub 106. This coupling may involve multiple spokes 104 that extend between rim 102 and hub 106. In other embodiments (not shown), hub 106 extends all the way to rim 102 and is directly attached to rim 102. As such, no intermediate components are present. The external surface of hub 106 may be made smooth to provide aerodynamic effect to the wheel during its assembly. However, one having ordinary skills in the art would understand that rim 102 and/or spokes 104 are optional components, and electricity generating bicycle wheel assembly 100 may be provided without these.

Axle 108 protrudes through hub 106 and typically extends on opposites sides of hub 106 as schematically shown in FIGS. 1B and 1C. Specifically, FIG. 1B shows electricity generating bicycle wheel assembly 100 prior to inserting axle 108 through hub 106. As shown, hub 106 has a through cavity 112 extending between opposites sides of hub 106. Through cavity 112 is configured for receiving axle 108 and may include bearings and other components allowing for hub 106 to rotate with respect to axle 108, as further explained below. Through cavity 112 also allows for various electricity generating components of electricity generating bicycle wheel assembly 100 to be rigidly attached to axle 108, as further explained below. FIG. 1C illustrates electricity generating bicycle wheel assembly 100 after inserting axle 108 through hub 106. Nuts 110 or other mechanical retainers or fasteners may be used to axially secure axle 108 with respect hub 106.

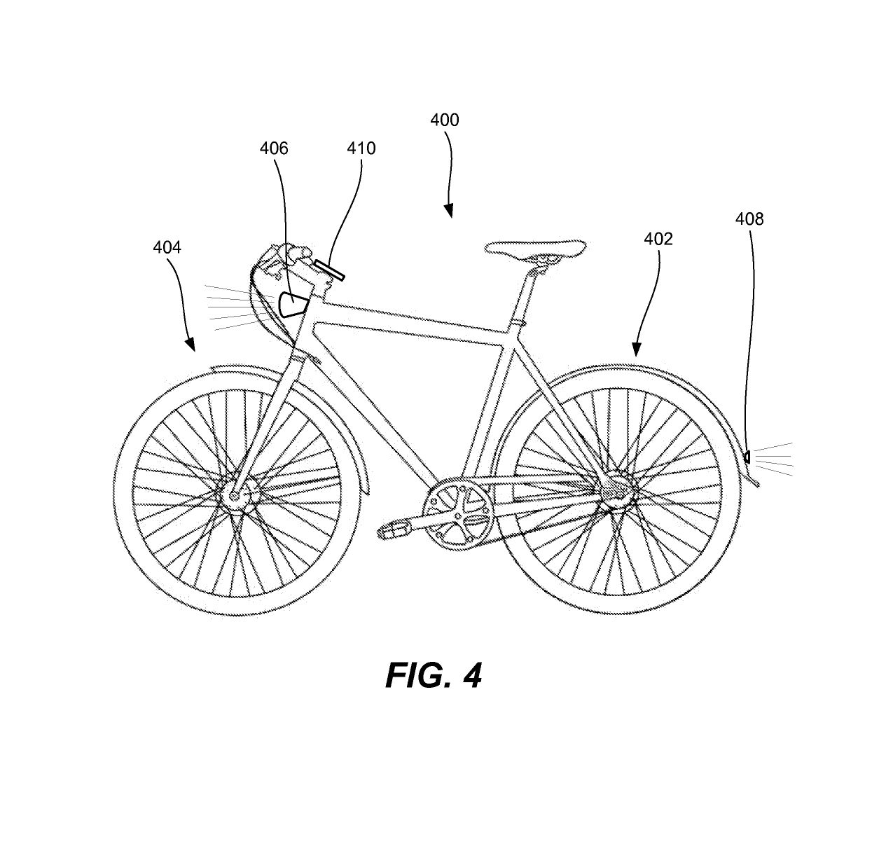

Axle 108 is configured to rigidly attach to a bicycle frame at these extensions on the opposite sides of hub 106. For example, axle 108 may attach to a front pivotable fork or a rear stationary frame of the bicycle. In certain embodiments further described below with reference to FIG. 4, one or both wheels of the bicycle include such electricity generating bicycle wheel assemblies. It should also be noted that this electricity generating bicycle wheel assembly may be used on bicycles having any number of wheels (e.g., unicycles, tricycles, or bicycles with four wheels). Furthermore, the electricity generating bicycle wheel assembly may also be used on other forms of transportation using bicycle wheels, such as buggies, child carriers, load carriers, recreational vehicles, and such.

Hub 106 may be a full enclosure as shown in FIG. 1A. In these embodiments, hub 106 may include at least one portion separable from the rest of hub 106 to access components of electricity generating bicycle wheel assembly 100 enclosed within hub. This access may be needed during assembly and repair of electricity generating bicycle wheel assembly 100. For example, hub 106 may include two plates which are attached along their edges to form hub 106. These “full enclosure” embodiments may be used for protecting the enclosed components from water and debris during operation of the bicycle.

In other embodiments, a hub does not form a full enclosure. For example, FIG. 1D includes an example of a different electricity generating bicycle wheel assembly 120 that includes a hub 126 formed as two rings positioned near two different ends of axle 128. These rings may be used for attachment of the spokes, but they do not have to be. In general, any component of the bicycle wheel that rotates with respect to its axle may be used as a hub. Therefore, the definition of the “hub” is not restrictive to any particular enclosure. Furthermore, the hub is generally positioned within boundaries of the wheel defined by its spokes or other rim-supporting components to ensure aerodynamic aspects as well as the integrated design of an electricity generating bicycle wheel assembly.

Returning to FIG. 1A, axle 108 is rotatably attached to hub 106. For example, a ball bearing or any other type of bearing (e.g., slip bearing, roller bearing) may be used for this purpose. As stated above, when an electricity generating bicycle wheel assembly is installed on a bicycle, axle 108 of this assembly is rigidly attached to the frame of the bicycle and does not rotate with the rest of the wheel. On other hand, hub 106 rotates together with the remaining part of the wheel, which allows for generating electricity, as will be now explained with reference to FIG. 2A.

FIG. 2A is a detailed schematic illustration of an electricity generating bicycle wheel assembly 200, in accordance with certain embodiments. Assembly 200 is shown without a rim and spokes, which may be a type of the assembly manufactured, supplied, and/or sold for future integration into a bicycle wheel. Assembly 200 includes a hub 202 and an axle 204 protruding through and rotatably attached to hub 202 using, for example, two bearings 206a and 206b. As explained above, axle 204 is configured to rigidly attach to a bicycle frame on each side of hub 202. Therefore, axle 204 may include threaded portions at both extending portions of axle 204.

Assembly 200 also includes an electrical generator 212 positioned within hub 202. As noted above, electrical generator 212 and other components of assembly 200 do not need to be enclosed by hub 202, as shown in FIG. 2A. Some of these other embodiments are schematically illustrated in FIG. 1D.

Returning to FIG. 2A, electrical generator 212 is rigidly mounted on axle 204 using, for example, a bracket 214. Such a mount may be a bracket or a strap attached to both electrical generator 212 and axle 204. Various mounting implementations would be readily apparent to one having ordinary skills in the art. Therefore, electrical generator 212 does not rotate when a bicycle wheel rotates, but remains stationary. This feature helps to avoid an unbalanced wheel effect. In some embodiments, instead of being mounted on the axle 204, the electrical generator 212 can be rigidly mounted on the hub 202 with the generator axle being rotatably coupled to the gear rigidly attached to the axle 204. This reverse configuration may also generate electricity.

Electrical generator 212 includes a generator axle 211 rotatably coupled to hub 202 such that rotation of hub 202 with respect to axle 204 facilitates rotation of generator axle 211 with respect to electrical generator 212. As shown in FIG. 2A, a gear mechanism including one or more gears 208 and 210 may be used for this purpose. One gear 208 may be coupled directly to hub 202, while another gear 210 may couple the first gear 208 to generator axle 211. In certain embodiments, an inner surface of hub 202 may have gear teeth for engaging with other gears, or the first gear may be rigidly attached to hub. A number and selection of gears may be provided to achieve required rotational speed of generator axle 211 for typical bicycling speed (e.g., 5-20 mph). In certain embodiments, a gear ratio of the one or more gears is at least about 10, such that each rotation of the hub with respect to the axle facilitates multiple rotations of the generator axle with respect to the electrical generator. It should be noted that a wheel diameter and other characteristics of the bicycle should be considered. Overall, generator axle 211 is rotated by rotation of hub 202 with respect to axle 204.

In certain embodiments, a gear mechanism is capable of engaging and disengaging generator axle 211 from hub 202. For example, electricity generation may be needed only for a specific time period (e.g., when it is dark in order to power bicycle lights, or for charging a mobile device or a battery, etc.) During other periods, a bicyclist may not want to provide additional power to drive rotation of generator axle 211. In these embodiments, a gear mechanism may include a mechanical and/or electro-chemical gear disengagement feature. However, in other embodiments, generator axle 211 may be continuously engaged with respect to hub 202.

Electrical power generated by electrical generator 212 is delivered to other bicycle components, such as lights and connectors further described below with reference to FIG. 4. These devices are typically positioned outside of assembly 200 and are attached to the bicycle frame. While electrical generator 212 is stationary, it is separated from the frame by rotating hub 202 and/or spokes during operation of the bicycle. Therefore, in order to deliver the electrical power from generator 212 to the frame, one or more electrical leads need to either go through a slip contact ring 216 as shown in FIG. 2A or through other stationary components, such as axle 204 as shown in 2B. Various examples of slip contacts are described in U.S. patent application Ser. No. 13/005,007, entitled “Device for sensing positions of a rotating wheel,” filed on Jan. 12, 2011, which is incorporated herein by reference in its entirety for the purposes of describing slip contacts. It should be noted that while electrical generator 212 generates voltage between two electrical leads, one of these leads may be the various conductive components of assembly 200 and bicycle. For example, a body of generator 212, mounting bracket 214, and/or axle 204 may be used for electricity transmission to the bicycle frame. Another lead may be provided by a separate wire that attaches to a slip contact ring 216 as shown in FIG. 2A or fed through an axle 204, as shown in FIG. 2B. In certain embodiments, two or more electrical leads are provided by slip contact ring 216 or axle 204. Specifically, FIG. 2A illustrates two wires 218 extending from generator 212 to slip contact ring 216, which in turn provide two external connections 217.

FIG. 2B illustrates an electricity generating bicycle wheel assembly 220, which includes a hub 222 and an electrical generator 223, in accordance with certain embodiments. Two electrical leads 224 extend from electrical generator 223 towards stationary axle 226 and then protrude within axle 226 towards one or two of its ends, forming two or four external connections 227. It should be noted that any number of leads can be arranged into this configuration.

FIG. 2C illustrates another electricity generating bicycle wheel assembly 230, which include a hub 232 and an electrical generator 233, in accordance with certain embodiments. Two electrical leads 235 extend from electrical generator 233 towards stationary axle 238, as well as to slip contact ring 236. In this embodiment, stationary axle 238 and slip contact ring 236 provide parallel paths for an electrical current. Specifically, these two components have external electrical leads 237a and 237b for making electrical connections.

FIG. 2D illustrates yet another electricity generating bicycle wheel assembly 240, which includes a hub 242 and an electrical generator 243, in accordance with certain embodiments. Similar to the design described above with reference to FIG. 2C, this assembly 240 includes two electrical leads 245 that extend from electrical generator 243 towards stationary axle 248, as well as to slip contact ring 246, and provide two sets of external electrical contacts 247a and 247b. However, in this embodiment, slip contact ring 246 provides one continuous contact and one intermittent contact. The continuous contact of slip contact ring 246 is shown with a continuous ring, while the intermittent contact is shown with multiple dots. When hub 242 rotates with respect to axle 248, the continuous contact maintains constant contact, while the intermittent repeatedly connects and disconnects. The frequency of these connections depends on the number of individual contact leads and rotational speeds. This intermittent contact may be used to generate flashing lights or other purposes.

FIG. 2E illustrates a electricity generating bicycle wheel assembly 250, which includes a hub 252 and two electrical generators 253a and 253b, in accordance with certain embodiments. Multiple generators may be used to provide additional electrical power and to better utilize the space within hub 252. Both electrical generators 253a and 253b may be connected to the same set of electrical leads (as shown in FIG. 2E) or different sets of leads (not shown).

As stated above, a generator axle may be rotatably coupled to a hub through a set of gears. A number of gears and their relative gear ratios allow for controlling rotational speed of the generator axle with respect to the rotational speed of the hub. FIG. 2F illustrates an electricity generating bicycle wheel assembly 260, which includes a hub 262 and electrical generator 263 coupled by a set of gears 265, 266, and 267. In this embodiment, additional gears are added (relative to the embodiment shown in FIG. 2A) to increase or decrease the gear ratio of the set.

In certain embodiments, when a rotational speed of the generator axle does not need to be geared up or down with respect to the rotational speed of the hub, an electricity generating bicycle wheel assembly may be constructed in such a way that an axle of the assembly is the same as the generator axle. In other words, the electrical generator may be positioned around the axle, and the coils of the electrical generator are positioned right on the axle of the assembly.

In certain embodiments, an electricity generating bicycle wheel assembly may include a battery or a capacitor that is charged from the electrical generator when the bicycle wheel is turning and may be used to power various electrical devices when the bicycle is stationary. FIG. 2G illustrates an electricity generating bicycle wheel assembly 270, which includes a hub 272 and an electrical generator 273 electrically connected to a battery 278. As shown, battery 278 is positioned within hub 272. However, a battery may also be external to assembly 270 and be attached, for example, to a bicycle frame. Any suitable rechargeable battery may be used for these purposes (e.g., a capacitor, a lithium ion battery, a lithium polymer battery, a nickel metal hydride battery, a nickel cadmium battery, or a lead acid battery). Other electrical components of the electricity generating bicycle wheel assembly may include inverters, transformers, diodes, etc.

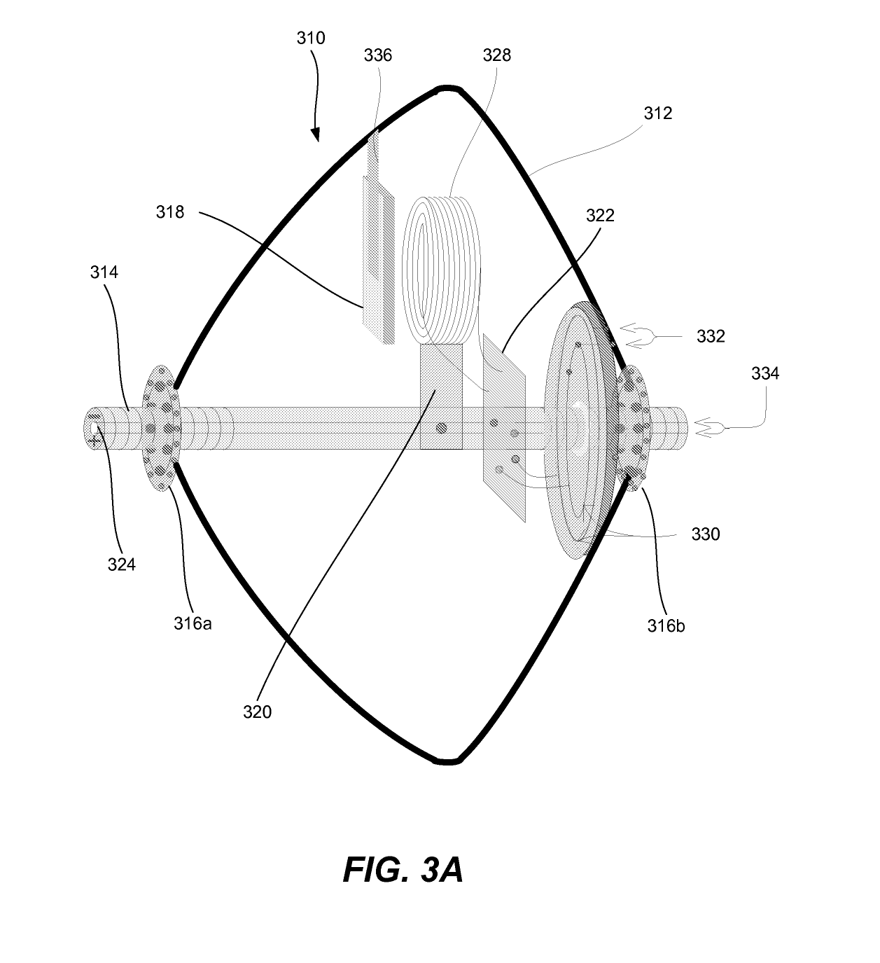

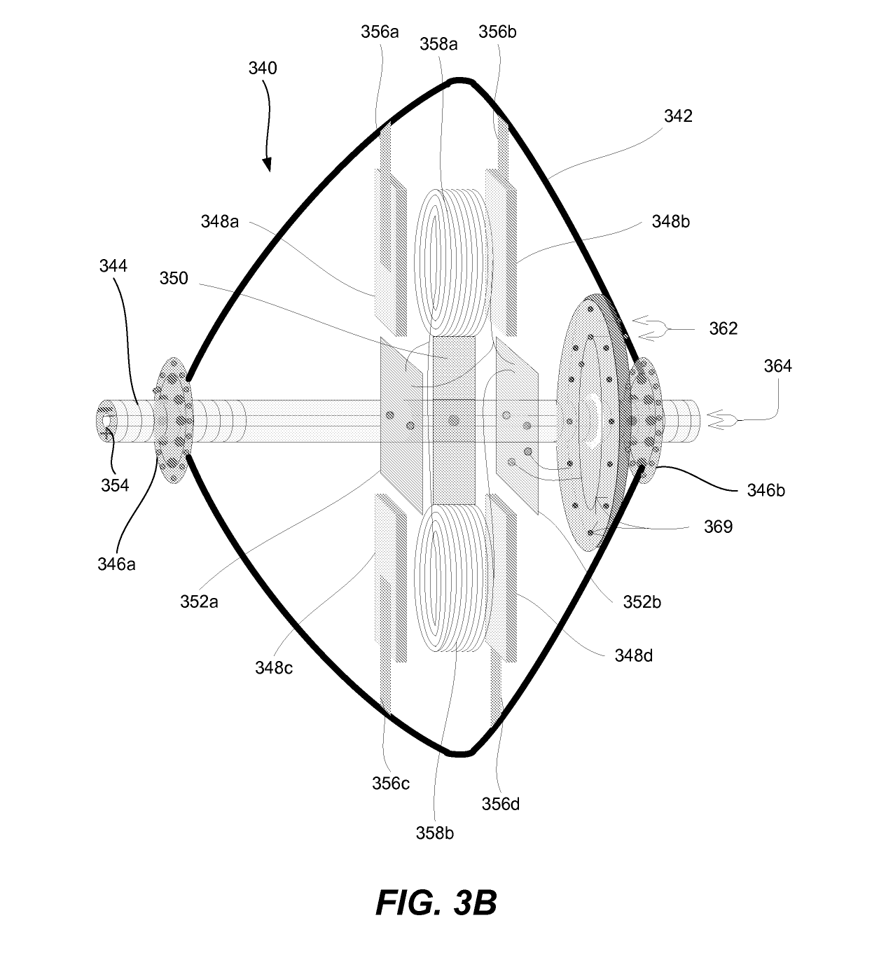

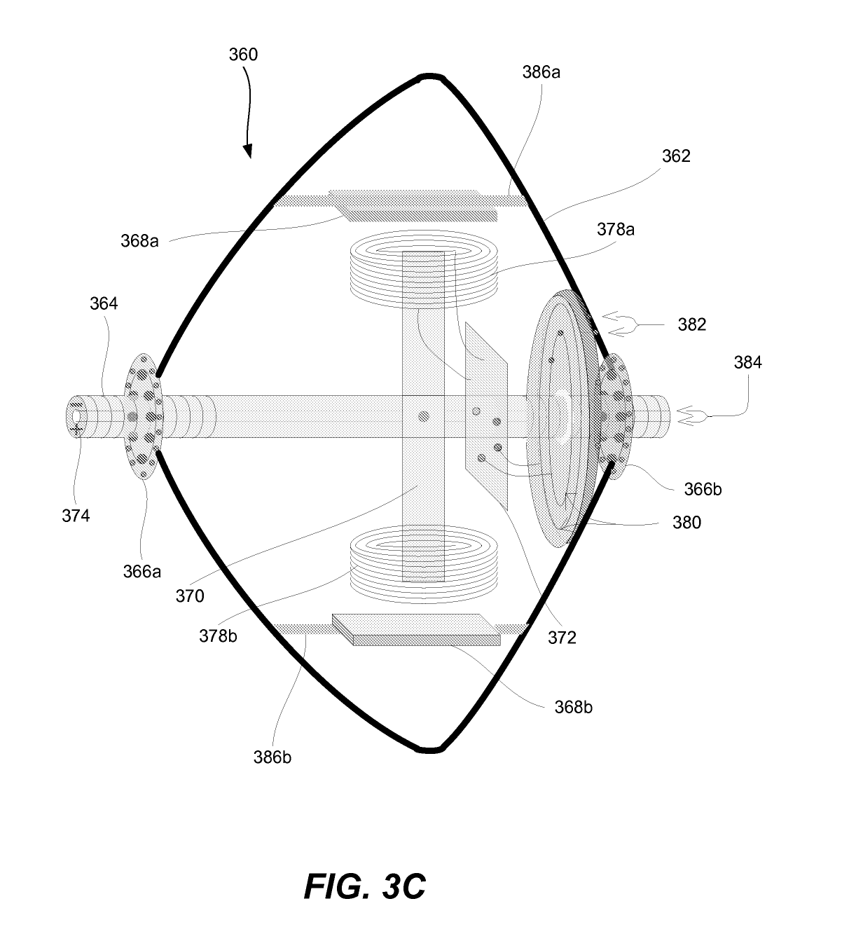

FIG. 3A illustrates an electricity generating bicycle wheel assembly 310 with the electricity being generated in a coil 328 coupled to a stationary axel 324 as the rotating hub 312 rotates and the magnet 318 mounted vertically inside the hub assembly using a mounting strip 336 passes by a stationary coil 328 attached to the axle. The coil 328 and the magnet 318 may supply the generated electricity to a battery installed on the circuit board 322. The electricity may then be supplied to the slip contact ring via two or more electrical leads. The contact ring may supply the electricity to an external hub 312.

FIG. 3B illustrates an electricity generating bicycle wheel assembly 340 with the electricity being generated in two wire coils 358a and 358b coupled to a stationary axel 344 as the wire coils 358a and 358b pass between rotating magnets 348a, 348b, 348c, and 348d which are mounted vertically inside the hub assembly using corresponding mounting strips 356a, 356b, 356c, and 356d. The coils 358a and 358b and the magnets 348a, 348b, 348c, and 348d may supply the generated electricity to one or more batteries installed on circuit boards 352a and 352b. The electricity may then be supplied to the slip contact ring and/or through within axel 344 via two or more electrical leads. The contact ring and two or more electrical leads may supply the electricity to an external hub 342.

FIG. 3C illustrates an electricity generating bicycle wheel assembly 360 with the electricity being generated in two wire coils 378a and 378b coupled to a stationary axel 374 as the wire coils pass by two rotating magnets 368a and 368b mounted perpendicularly inside the hub assembly 362 using corresponding mounting strips 386a and 386b. The wire coils 378a and 378b and the magnets 368a and 368b may supply the generated electricity directly to the external hub 362 via the slip contact ring and two or more electrical leads. A diode bridge can be utilized to convert AC to DC power when coils and magnets are used instead of AC/DC generator. The AC/DC conversion may perform within a circuit board 372. The positions of magnets and wire coils are interchangeable for the purpose of generating electricity.

Also provided is a bicycle that includes one or more electricity generating bicycle wheel assemblies. FIG. 4 is a schematic representation of a bicycle 400 having a front wheel 404 and a back wheel 402. Either one of these wheels or both wheels may include electricity generating bicycle wheel assemblies. Electricity produced by these assemblies may be used to power a front light 406, a back light 408, and/or other electrical devices 410. Some examples of such devices 410 include a cell phone, a GPS system, and a music player. In certain embodiments, a bicycle may include one or more connectors for connecting various electrical devices that may or may not be used during the operation of a bicycle. For example, a rider may want to charge his laptop while riding a bicycle. The laptop may be stored in the rider's backpack. An electrical connector positioned anywhere on the bicycle frame (e.g., under the seat post) may be used for connecting the laptop.

What is claimed is:

1. An electricity generating bicycle wheel assembly configured to generate electrical power, the electricity generating bicycle wheel assembly comprising:
a hub;
an axle protruding through and rotatably attached to the hub, the axle configured to rigidly attach to a bicycle frame on each side of the hub; and
an electrical generator positioned within the hub and rigidly attached to the axle, the electrical generator comprising a generator axle rotatably coupled to the hub such that rotation of the hub with respect to the axle facilitates rotation of the generator axle with respect to the electrical generator.

2. The electricity generating bicycle wheel assembly of claim 1, further comprising one or more gears positioned within the hub and rotatably coupling the generator axle to the hub.

3. The electricity generating bicycle wheel assembly of claim 2, wherein a gear ratio of the one or more gears is at least about 10, such that each rotation of the hub with respect to the axle facilitates multiple rotations of the generator axle with respect to the electrical generator.

4. The electricity generating bicycle wheel assembly of claim 1, further comprising a capacitor or a battery electrically positioned within the hub and electrically coupled to the electrical generator.

5. The electricity generating bicycle wheel assembly of claim 1, further comprising one or more electrical leads electrically coupled to the electrical generator and extending outside of the hub.

6. The electricity generating bicycle wheel assembly of claim 5, wherein the one or more electrical leads protrude inside the axle.

7. The electricity generating bicycle wheel assembly of claim 5, wherein one of the one or more electrical leads comprises conductive components of the bicycle wheel assembly.

8. The electricity generating bicycle wheel assembly of claim 7, wherein the conductive components comprises one or more of the following: the axle and the hub.

9. The electricity generating bicycle wheel assembly of claim 1, further comprising a mounting strap rigidly coupling the electrical generator to the axle.

10. The electricity generating bicycle wheel assembly of claim 1, further comprising a rim rigidly coupled to the hub, the rim being configured to receive a tire.

11. The electricity generating bicycle wheel assembly of claim 10, wherein the rim rigidly is coupled to the hub by multiple spokes.

12. The electricity generating bicycle wheel assembly of claim 10, wherein the hub extends to the rim and is in direct connection with the rim.

13. The electricity generating bicycle wheel assembly of claim 1, further comprising one or more sprockets rigidly coupled to the hub.

14. The electricity generating bicycle wheel assembly of claim 1, further comprising a slip contact ring.

15. A bicycle comprising a frame and a wheel comprising an electricity generating bicycle wheel assembly comprising:
a hub;
an axle protruding through and rotatably attached to the hub, the axle configured to rigidly attach to the frame on each side of the hub; and
an electrical generator positioned within the hub and rigidly attached to the axle, the electrical generator comprising a generator axle rotatably coupled to the hub such that rotation of the hub with respect to the axle facilitates rotation of the generator axle with respect to the electrical generator.

16. The bicycle of claim 15, further comprising a second wheel comprising a second electricity generating bicycle wheel assembly comprising:
a second hub;
a second axle protruding through and rotatably attached to the second hub, the axle configured to rigidly attach to the frame on each side of the second hub; and
a second electrical generator positioned within the second hub and rigidly attached to the second axle, the second electrical generator comprising a second generator axle rotatably coupled to the second hub such that rotation of the second hub with respect to the second axle facilitates rotation of the second generator axle with respect to the second electrical generator.

17. The bicycle of claim 15, further comprising one or more lights electrically coupled to the electrical generator of the electricity generating bicycle wheel assembly.

18. The bicycle of claim 15, further comprising a connector comprising at least two electrical contacts electrically coupled to the electrical generator, the connector configured for connection to one or more external electrical devices selected from a group comprising a light and a cell phone.

19. The bicycle of claim 15, further comprising a capacitor or a battery electrically coupled to the electrical generator, wherein the capacitor or the battery is positioned inside the hub.

20. The bicycle of claim 15, further comprising a capacitor or a battery electrically coupled to the electrical generator, wherein the capacitor or the battery is positioned outside the hub.

21. An electricity generating bicycle wheel assembly configured to generate electrical power, the electricity generating bicycle wheel assembly comprising:
a hub;
an axle protruding through and rotatably attached to the hub, the axle configured to rigidly attach to a bicycle frame on each side of the hub;
one or more wire coils installed on the axle; and
one or more magnets coupled to the hub, the one or more the wire coils being configured to generate electricity as the hub rotates and the one or more wire coils and the one or more magnets pass by each other.

22. An electricity generating bicycle wheel assembly configured to generate electrical power, the electricity generating bicycle wheel assembly comprising:
a hub;
an axle protruding through and rotatably attached to the hub, the axle configured to rigidly attach to a bicycle frame on each side of the hub; and
an electrical generator positioned within the hub and rigidly attached to the hub, the electrical generator comprising a generator axle rotatably coupled to the gear rigidly attached to the axle such that rotation of the hub with respect to the axle facilitates rotation of the generator axle with respect to the electrical generator.

23. An electricity generating bicycle wheel assembly configured to generate electrical power, the electricity generating bicycle wheel assembly comprising:
a hub;
an axle protruding through and rotatably attached to the hub, the axle configured to rigidly attach to a bicycle frame on each side of the hub;
one or more magnets installed on the axle; and
one or more wire coils coupled to the hub, the one or more of the wire coils being configured to generate electricity as the hub rotates and the one or more wire coils and the one or more magnets pass by each other.
